(19) United States
(12) Patent Application Publication
(10) Pub. No.: US 2026/0134204 A1
(43) Pub. Date: May 14, 2026

(54) Hybrid Execution of Multi-Furcated Machine Learning Models

(71) Applicant: DeepMind Technologies Limited, London (GB)

(72) Inventors: Jian Li, Mountain View, CA (US); Yong Cheng, Mountain View, CA (US)

(21) Appl. No.: 18/942,022

(22) Filed: Nov. 8, 2024

(51) Int. Cl. G06F 40/20

(52) U.S. Cl. CPC G06F 40/20

(57) ABSTRACT

Provided is a hybrid, multi-device architecture for serving machine learning models such as, for example, so-called “large language models” (LLMs) or “large multi-modal models” (LMMs). Example systems can utilize both edge device and server components to enhance privacy and performance. In particular, in some example systems, the heavy computational tasks are handled by the server, which houses powerful machine-learned model portions, while the edge device (e.g., which may be a user device such as a laptop, smartphone, etc.) manages privacy-preserving operations such as embedding and unembedding of tokens. This division of labor allows the edge device to process sensitive data locally, maintaining user privacy by preventing the server from directly accessing raw user data.

### FIELD

The present disclosure relates generally to machine learning processes and machine-learned devices and systems. More particularly, the present disclosure relates to an approach for performing hybrid, multi-device execution of multi-furcated machine learning models.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a first computing system. The first computing system includes one or more processors and one or more non-transitory computer-readable media that collectively store one or more first machine-learned model portions which may include a first set of machine-learned model parameters. To process a model input to generate a model output, the one or more first machine-learned model portions are configured to interoperate with one or more second, different machine-learned model portions may include a second, different set of machine-learned model parameters, where the one or more second, different machine-learned model portions are stored at a second, different computing system. The system also includes instructions that, when executed by the one or more processors, cause the first computing system to perform operations, the operations may include: obtaining the model input; processing the model input with at least some of the one or more first machine-learned model portions to generate a first intermediate representation; transmitting the first intermediate representation to the second computing system; receiving one or more second intermediate representations from the second computing system, the one or more second intermediate representations having been generated by the one or more second machine-learned model portions based at least in part on the first intermediate representation; and generating the model output based at least in part one or more second intermediate representations. Other embodiments of this aspect include corresponding computer systems, apparatus, and computer programs recorded on one or more computer storage devices, each configured to perform the actions of the methods.

Example implementations may include any combination of one or more of the following features. The first computing system where generating the model output based at least in part one or more second intermediate representations may include processing the one or more second intermediate representations with at least some of the one or more first machine-learned model portions to generate the model output. For each forward inference, and other than the transmission of the first intermediate representation from the first computing system to the second computing system, dataflow between the second machine-learned model portions and the first machine-learned model portions is unidirectional from the second machine-learned model portions to the first machine-learned model portions. At least some of the one or more first machine-learned model portions may include non-linear transformations. At least some of the one or more first machine-learned model portions may include ladder side tuning adapters. The one or more second machine-learned model portions may include a plurality of model layers, and where the one or more first machine-learned model portions may include a plurality of ladder side tuning adapters respectively associated with the plurality of model layers, where each ladder side tuning adapter receives and processes one of the second intermediate representations output by one of the plurality of model layers to generate one of the first intermediate representations. In a forward inference dataflow, two or more of the first machine-learned model portions operate in parallel with two or more of the second machine-learned model portions. At least some of the one or more first machine-learned model portions perform embedding of the model input and unembedding of the model output. The first set of machine-learned model parameters were learned while holding the second set of machine-learned model parameters fixed. A first number of parameters included in the first set of machine-learned model parameters is ten percent or less than a second number of parameters included in the second set of machine-learned model parameters. For each forward inference, the first computing system makes only a single remote procedure call to the second computing system. The one or more second machine-learned model portions may include one or more layers of an existing pre-trained model. The first computing system may be or include a user computing device. The first computing system may be or include a private computing system. The second computing system may have greater computational speed to the first computing system. Implementations of the described techniques may include hardware, a method or process, or computer software on a computer-accessible medium.

One general aspect includes a second computing system configured to interoperate with a first computing system. The second computing system includes one or more processors and one or more non-transitory computer-readable media that collectively store one or more second machine-learned model portions which may include a second set of machine-learned model parameters. To facilitate processing of a model input to generate a model output, the one or more second machine-learned model portions are configured to interoperate with one or more first, different machine-learned model portions which may include a first, different set of machine-learned model parameters, where the one or more first, different machine-learned model portions are stored at the first computing system. The system also includes instructions that, when executed by the one or more processors, cause the second computing system to perform operations, the operations may include: receiving a first intermediate representation from the first computing system, processing the first intermediate representation with the one or more second machine-learned model portions to generate one or more second intermediate representations, and transmitting the one or more second intermediate representations to the first computing system. Other embodiments of this aspect include corresponding computer systems, apparatus, and computer programs recorded on one or more computer storage devices, each configured to perform the actions of the methods.

Example implementations may include any combination of one or more of the following features. The second computing system where neither the model input nor the model output are inferable from the first intermediate representation. Implementations of the described techniques may include hardware, a method or process, or computer software on a computer-accessible medium.

One general aspect includes a distributed computing system. The distributed computing system includes two or more different computing devices that respectively store two or more different subsets of a multi-furcated machine learning model. The multi-furcated machine learning model is configured to process a model input to generate a model output. A first computing device of the two or more different computing devices is configured to perform embedding operations to embed the model input and unembedding operations to generate the model output. Other embodiments of this aspect include corresponding computer systems, apparatus, and computer programs recorded on one or more computer storage devices, each configured to perform the actions of the methods.

Example implementations may include any combination of one or more of the following features. The distributed computing system where the two or more different computing devices that respectively store the two or more different subsets of the multi-furcated machine learning model may include three or more different computing systems that respectively store three or more different subsets of the multi-furcated machine learning model. The first computing device may be or include a user computing device. Implementations of the described techniques may include hardware, a method or process, or computer software on a computer-accessible medium.

### BRIEF DESCRIPTION OF THE DRAWINGS

FIG. 1 provides a block diagram of an example bi-furcated machine-learned model according to example implementations of aspects of the present disclosure.

FIG. 2 provides a block diagram of an example multi-furcated machine-learned model according to example implementations of aspects of the present disclosure.

FIG. 3 provides a block diagram of an example general architecture for a bi-furcated model according to example implementations of aspects of the present disclosure.

FIG. 4 provides a block diagram of an example detailed architecture of a machine-learned model involving parameter-efficient tuning layers according to example implementations of aspects of the present disclosure.

FIG. 5 provides a block diagram of an example network topology involving multiple edge devices and a central server according to example implementations of aspects of the present disclosure.

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

### DETAILED DESCRIPTION

Example aspects of the present disclosure are directed to a hybrid, multi-device architecture for serving machine learning models such as, for example, so-called “large language models” (LLMs) or “large multi-modal models” (LMMs). Example systems described herein can utilize both edge device and server components to enhance privacy and performance. In particular, in some example systems, the heavy computational tasks are handled by the server, which houses powerful machine-learned model portions, while the edge device (e.g., which may be a user device such as a laptop, smartphone, etc.) manages privacy-preserving operations such as embedding and unembedding of tokens. This division of labor allows the edge device to process sensitive data locally, maintaining user privacy by preventing the server from directly accessing raw user data.

More particularly, the present disclosure proposes a “multi-furcated” machine learning model, where different portions of the model are stored and executed across multiple different computing systems. However, these distributed model portions interoperate to process a model input to collectively produce a model output. This multi-furcated architecture allows for the distribution of computational tasks according to the capabilities of each computing system, such as performing initial data processing on a user's device for privacy reasons and completing more complex computations on a powerful server. To provide an example, a smartphone may handle embedding and initial layer processing, while a cloud server performs intensive deep learning computations. This division not only optimizes resource use but also enhances data security and processing speed by minimizing the need to transfer sensitive or large volumes of data between devices and servers.

One example system includes a machine learning model that is bi-furcated across two different computing systems: a “first computing system” and a “second computing system.” The first computing system can store and implement one or more first machine-learned model portions that include a first set of machine-learned model parameters. These first model portions can be designed to interoperate with second, different machine-learned model portions that are stored at the second computing system and which include a second set of machine-learned model parameters. The operations of the first computing system can include obtaining a model input, processing the model input with at least some of the first machine-learned model portions to generate a first intermediate representation, and then transmitting this first intermediate representation to the second computing system. The second computing system can process the first intermediate representation with the one or more second machine-learned model portions to generate one or more second intermediate representations and transmit the one or more second intermediate representations to the first computing system. The first computing system can receive the second intermediate representations processed by the second system and use these second intermediate representations to generate the final model output.

Various descriptions contained herein discuss example implementations where the first computing system is a user device or other edge device which stores user data but which has relatively less powerful/plentiful computational resources; while the second computing system is a server system which has relatively more powerful/plentiful computational resources. However, various different arrangements of computing systems can be used as well, including multiple server systems, multiple peer edge devices, and/or various combinations thereof. While example descriptions focus on models that are bi-furcated across two systems, the present disclosure equally encompasses models that are multi-furcated across three or more different systems.

In some implementations, the interaction(s) between the device and the server can be primarily characterized by the exchange of intermediate representations rather than raw data. This means that the device sends processed data (e.g., first intermediate representation(s)) to the server, which then processes this data further to generate second intermediate representation(s). These are sent back to the device where the final output is produced. This method of data exchange helps in safeguarding user data since the raw inputs and outputs are never directly exposed to the server.

In particular, in one example in which the first computing system is a user device and the second computing system is a server system, operations such as embedding, unembedding, and/or sampling can be conducted on the user device. Embedding converts raw data into a format suitable for model processing, while unembedding converts the processed data back into a human-readable format. This ensures that the server never directly accesses the raw input or output tokens. This approach enhances user privacy by processing sensitive data locally on the user's device and only transmitting non-sensitive intermediate data to the server for further processing.

In some implementations, the first model portions can include one or more adapter layers, while the second model portions can include main model layers or backbone layers. This setup strategically places the adapter layers on the device side, where they perform initial data processing and/or customization tasks that are relatively lightweight. The backbone layers on the server side can handle the more intensive computational aspects of the model. Further, in some implementations, the adapter layers can be fine-tuned with specific datasets, such as user-specific data, which has not been observed by the server. This makes the embeddings or other intermediate representations generated by these adapter layers difficult or impossible for the server to decipher.

In some implementations, the adapter layers can include lightweight, parameter-efficient adapters known as Ladder Side-Tuning (LST) layers. LST adapter layers can optimize latency in the multi-furcated machine learning model. LST adapters can be designed to operate in a manner that ensures efficient communication and processing speeds between the device and the server. Specifically, unlike Low Rank Adaptation (LoRA) adapters, which require a two-way dependency between the server and the device that can significantly increase latency, LST adapters minimize this issue by simplifying the data flow to primarily one direction. This architectural choice is beneficial for applications requiring real-time or near-real-time responses, as it reduces the time taken for data to be processed across the distributed components of the system. LST adapter layers are described in Sung et al., LST: Ladder Side-Tuning for Parameter and Memory Efficient Transfer Learning, arXiv:2206.06522 [cs. CL]. LoRA adapters are described in Hu et al., LoRA: Low-Rank Adaptation of Large Language Models, arXiv:2106.09685 [cs. CL].

In some implementations, during forward inference dataflow, two or more of the first machine-learned model portions (e.g., which may be adapter layers), operate in parallel with two or more of the second machine-learned model portions (e.g., which may be the main model or backbone layers). This parallel operation enables simultaneous processing of data across different layers, enhancing the efficiency and speed of the model's output generation. This parallelism improves the ability of the model to leverage the computational strengths of both local and server resources optimally.

In some implementations, to further enhance the system's efficiency, the data flow between the second computing system and the first computing system is predominantly unidirectional. For example, beyond the initial transmission of the first intermediate representation, the flow of data can be unidirectional from the second system to the first system. This unidirectional flow from the second system to the first system reduces the risk of data leakage and simplifies the communication protocol, thereby potentially reducing latency and increasing response speed. Specifically, unidirectional data flow allows the second system (e.g., which may be a relatively lower latency system such as a server) to perform its full computations independently, without needing to await any further intermediate computations from the first system (e.g., which may be a relatively higher latency system such as an edge device).

In some implementations, for each forward inference of the model, the first computing system is designed to make only a single remote procedure call (RPC) to the second computing system. This streamlined communication protocol minimizes network latency and reduces the bandwidth required for data transmission. Specifically, by limiting the interaction to a single RPC, the synchronization between the two systems (e.g., the edge device and the server) is simplified, increasing the security of data transmission by reducing the exposure to network-based threats.

In some implementations, the first set of machine-learned model parameters are trained while keeping the second set of machine-learned model parameters fixed. Specifically, in some implementations, the second machine-learned model portions can include one or more layers of an existing pre-trained model, which remains unaltered during the training of the first set of parameters. This approach allows for the integration of new, device-specific functionalities or privacy measures without compromising the integrity and the established effectiveness of the pre-trained model housed on the server.

In some implementations, neither the model input nor the model output are directly inferable from the first intermediate representation sent from the device to the server. For example, the proposed architecture can ensure that the intermediate representation, which could include layer-level activation functions, is designed such that it obfuscates the original input data.

According to another aspect of the present disclosure, the system's design allows for the possibility of running multiple edge devices, each with their own respective model portions, concurrently connected to the same server. In particular, multiple edge devices with different respective first model portions can connect to the same server that stores a shared set of second model portions. This results in a scalable and efficient system capable of handling simultaneous requests from various users. This feature is beneficial in environments where numerous devices need to access advanced computational resources, such as in enterprise settings or during large-scale deployments of Internet of Things (IoT) devices. For example, multiple smartphones, tablets, or specialized hardware devices can each perform local computations and interact with a centralized server that processes and coordinates more complex tasks.

Furthermore, existing server-side optimizations such as continuous batching, early exit strategies, key-value caching, Virtual Large Language Model (VLLM) serving, etc. are still applicable and beneficial. These optimizations can improve the efficiency and performance of the server components of the multi-furcated machine learning model. Continuous batching allows the server to process multiple requests simultaneously, improving throughput. Early exit mechanisms enable the server to terminate processing for simpler queries early, saving computational resources. Meanwhile, VLLM can enable the server to continuously wait for clients to connect and send requests concurrently. These optimizations collectively improve the efficiency of the server. One example of VLLM is described at Kwon et al., Efficient Memory Management for Large Language Model Serving with PagedAttention, arXiv:2309.06180 [cs.LG].

The systems and methods of the present disclosure provide a number of technical effects and benefits. As one example, the hybrid, multi-furcated architecture of the machine learning model significantly enhances the efficiency of data processing by strategically distributing computational tasks between edge devices and servers. This distribution allows the system to leverage the computational power of servers for intensive tasks while utilizing edge devices for initial data processing and privacy-sensitive operations. Such an arrangement minimizes the transfer of large volumes of data and sensitive information, effectively reducing processing time and bandwidth usage.

As another example technical effect, the technology improves data security by processing sensitive data locally on user devices and only transmitting less-sensitive, intermediate representations to the server. This approach limits the exposure of raw data, safeguarding user privacy. By embedding, unembedding, and sampling data locally, the system ensures that sensitive information does not leave the user's device in an unencrypted form, thereby enhancing the overall security of the data handling process.

As another example technical effect, the proposed system optimizes the management of computational resources through the relative distribution of adapter layers and main model layers, where lightweight, parameter-efficient adapters operate on the less powerful edge devices. This setup not only ensures that the edge devices operate within their computational limits but also allows the more powerful server components to focus on executing the more demanding aspects of the machine learning model. This strategic allocation of tasks ensures that each component of the system operates optimally, leading to improved overall performance and resource utilization. Various example implementations are described herein with respect to the accompanying Figures.

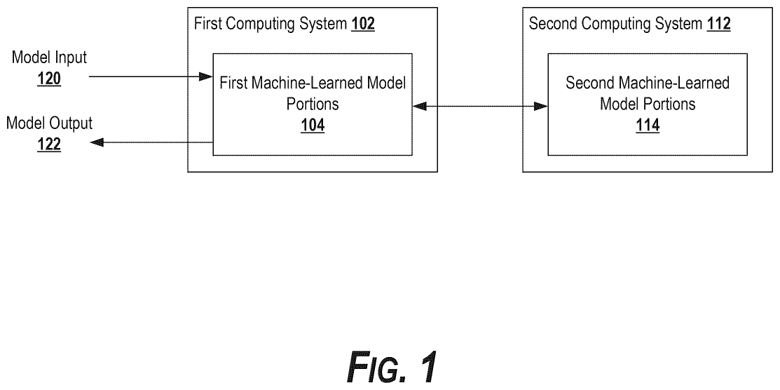

FIG. 1 illustrates an example bi-furcated machine-learned model. The model is implemented by a first computing system 102 and a second computing system 112. Each computing system contains distinct machine-learned model portions.

Specifically, the first computing system 102 can include one or more first machine-learned model portions 104. These portions can process a model input 120 to generate one or more first intermediate representations. The first computing system 102 can be a user device or an edge device. It can have relatively less computational resources as compared to the second computing system 112.

The second computing system 112 can include one or more second machine-learned model portions 114. These portions can process the one or more first intermediate representation(s) from the first computing system 102 to generate one or more second intermediate representations. The second computing system 112 can be a server system. It can have relatively more computational resources than the first computing system 102.

The first computing system 102 can receive the second intermediate representation(s) from the second computing system 112. It can use these representations to generate a model output 122.

In some implementations, the model input 120 and model output 122 can be textual inputs and/or outputs. In other implementations, other modalities of data can be input and/or output. Examples of these modalities include audio, visual, and/or tactile data. The model input 120 can receive various forms of data. The model output 122 can produce corresponding forms of data. These forms can depend on the specific application and configuration of the first computing system 102 and the second computing system 112.

Further, while FIG. 1 illustrates that the model input 120 enters the first computing system 102 and the model output 122 exits from the first computing system 102, other configurations can be possible as well. For example, in some cases, the model output 122 may be generated by or otherwise exit from the second computing system 112.

In some implementations, the first machine-learned model portions 104 in the first computing system 102 can include Ladder Side-Tuning, or LST, style adapters. These LST adapters can be configured to perform initial data processing tasks. The LST adapters can be an example of lightweight, parameter-efficient adapters. They can operate to process the model input 120 into an intermediate form. The processed intermediate form can then be transmitted to the second computing system 112 for further processing by the second machine-learned model portions 114.

In some implementations, the second machine-learned model portions 114 in the second computing system 112 can run on servers. These servers can include hardware accelerators such as TPUs or GPUs. This configuration allows heavy computation to occur on the server. Thus, in some cases, the second machine-learned model portions 114 can be characterized as powerful and/or general. The servers can handle extensive data processing tasks by leveraging the computational capabilities of the TPUs or GPUs. Multiple servers can work in concert to process data efficiently.

In some implementations, the first machine-learned model portions 104 can be personalized model portions that have been trained, finetuned, or otherwise personalized for user-specific data. These first machine-learned model portions 104 can include adapters or specialized layers that are specific to the data or preferences of individual users. In some implementations, the second machine-learned model portions 114 can be standard model portions that are shared amongst multiple users. These second machine-learned model portions 114 can include a pre-trained backbone model that performs general tasks applicable across different users.

In some implementations, the training of the first machine-learned model portions 104 can occur exclusively on the first computing system 102. The second machine-learned model portions 114 in the second computing system 112 can remain unchanged during this process. The first computing system 102 can perform the training using local data. This local data can be specific to the user or device associated with the first computing system 102. Examples of such data could include user preferences or device-specific information. The training can adapt the first machine-learned model portions 104 to this local data.

To provide an example, the bi-furcated model can represent or include a finetuned model “B” that builds upon a pretrained general knowledge model “A”. The finetuning can incorporate private information to modify the weights of model “A” and/or add new weights to the model “A” to create the model “B”. These modifications can be stored solely in the first computing system 102, potentially enhancing privacy by limiting server access to the finetuned details.

In some implementations, the proposed bi-furcation can provide privacy and customization. For example, if the adapters in the first computing system 102 are finetuned with a set of user-specific data, it can be very challenging or impossible for the second computing system 112 to extract any information from the embedded tokens for this user-specific data. This scenario can occur because the first computing system 102 processes the initial data and converts it into an intermediate form that the second computing system 112 uses for further processing. The intermediate form can obscure the details of the original input data, limiting the information available to the second computing system 112.

Specifically, in some implementations, embedding, unembedding, and/or sampling can occur exclusively at the first computing system 102. The second computing system 112 processes only the intermediate representations received from the first computing system 102. Therefore, the second computing system 112 does not directly see the inputs or outputs (e.g., the model input 120 and/or the model output 122).

As one example, the embedding tables associated with embedding and unembedding operations can fit within the memory constraints of common devices like smartphones. This enables the use of different embedding tables on the first computing system 102 and the second computing system 112 to further obscure the data processed and transmitted between these systems.

Thus, while the second computing system 112 can process data further after receiving intermediate representation(s) from the first computing system 102; in some implementations, it may not directly access or infer the finetuned private information embedded in the first computing system 102. Specifically, performing the embedding and un-embedding on the first computing system can avoid direct transmission of sensitive data such as token_ids or reply strings to the second computing system 112.

To provide an example, in some implementations, the first computing system 102 can be a device configured to perform multiple operations related to data processing and interaction with a server system. The first computing system 102 can include components that accept remote procedure calls (RPCs) containing activation output from the backbone model, potentially with a buffer. These components can calculate device operations, such as dense operations of Ladder Side-Tuning (LST) for each layer. Additionally, they can run unembedding, softmax, sampling algorithms, and detokenization processes. Furthermore, these components can run tokenization and embedding, and send the results to the server.

In some implementations, the second computing system 112 can be a component server. This component server can accept an embedded vector as input. This input method can be used instead of a string during prefill or a token id during decoding. The second computing system 112 can return an output activation for each layer.

In some implementations, the communication between the first computing system 102 and the second computing system 112 can include encrypted data transfers. Encryption algorithms such as AES or RSA can be used to secure the data during transmission. This ensures that intermediate representations transmitted are protected against unauthorized access.

In some implementations, some or all of any LST layers present in the first computing system 102 can utilize sparse transformations. These transformations can selectively activate certain parameters within the model for specific inputs, reducing the computational burden while maintaining processing efficacy. This method can help in optimizing the processing speed and resource utilization.

In some implementations, the second computing system 112 can perform key-value caching. In particular, the key-value caching in the second computing system 112 can employ an LRU (Least Recently Used) algorithm to manage cache space efficiently. When the kv cache erasing is triggered, the cache entries related to the session are purged, ensuring that data from completed sessions do not occupy valuable cache space.

In some implementations, the first computing system 102 can selectively determine when and/or whether to engage with the second computing system 112. This determination can be based on specific criteria, such as the complexity of the model input 120 or the computational load on the first computing system 102. The first computing system 102 can make this decision autonomously. Alternatively, it can follow a predefined protocol. The engagement can include sending a first intermediate representation to the second computing system 112 for further processing. The criteria for engagement can vary depending on the application or the configuration of the first computing system 102. Examples of such criteria can include data sensitivity, processing urgency, or resource availability.

As an example, in some implementations, the first computing system 102 can use a threshold-based mechanism to decide when to engage the second computing system 112. If the computational load on the first computing system 102 exceeds a predefined threshold, or if the complexity of the model input 120 requires more intensive computation, the system can automatically initiate data transfer to the second computing system 112 for further processing.

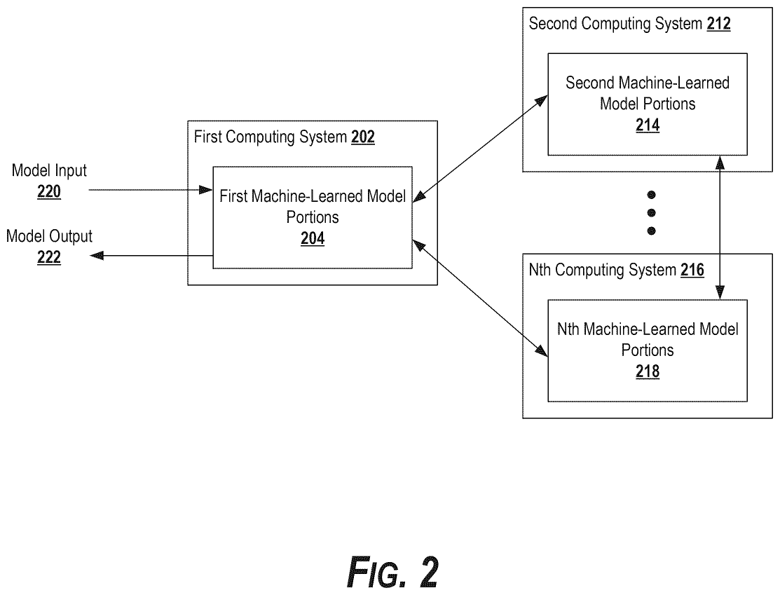

FIG. 2 depicts a multi-furcated machine-learned model that includes multiple computing systems, each equipped with unique machine-learned model portions. This configuration allows for a structured yet flexible approach to processing data through various computational stages.

The first computing system 202 is equipped with one or more first machine-learned model portions 204. This system can initiate the processing by receiving a model input 220, which it uses to generate a first intermediate representation. Typically, the first computing system 202 can serve as an example of a user device or an edge device, which might possess relatively limited computational resources compared to more robust server systems.

Following the first computing system 202, the model is also implemented using additional computing systems, such as the second computing system 212 and extending to an Nth computing system 216. Each of these systems houses machine-learned model portions, specifically the second machine-learned model portions 214 and the Nth machine-learned model portions 218, respectively. These systems are tasked with processing the intermediate representations passed down from the preceding system in the sequence. Each system can further refine or transform these representations, contributing sequentially to the progression of data processing.

The model processing can culminate in the generation of the model output 222, which is then outputted from the first computing system 202.

The N different computing systems can function in a sequential manner, where each system processes an input and passes the result to the next system in the sequence. Alternatively, they can operate in parallel, where different systems process different parts or aspects of the data simultaneously, potentially speeding up the overall data processing time. Alternatively, some portions can operate in sequence while other portions may operate in parallel.

Communication between the N different computing system can be orchestrated in various ways. One method involves a central orchestrator, which may be the first computing system 202 for example, which coordinates the flow of data and commands across all systems. This central orchestrator approach ensures a controlled and orderly processing sequence. Another method is peer-to-peer communication, where each computing system can directly communicate with one or more other systems in the network without central coordination. This peer-to-peer approach can enhance flexibility and reduce bottlenecks associated with a single point of control.

Each of the N different computing systems can represent or include different types of devices or server systems, each specifically tailored to handle particular computational tasks efficiently. This multi-furcated approach allows the model to leverage the distinct computational strengths of various systems, enhancing the overall efficiency and effectiveness of the model processing.

In FIG. 2, the active participation of different computing systems in the forward processing of data can be selectively controlled based on various characteristics. These characteristics can include computational demand, data type, user identity, and other relevant factors.

Each computing system, such as the first computing system 202, the second computing system 212, and the Nth computing system 216, can be selected to handle specific tasks based on their computational capabilities. For example, the first computing system 202 can process initial data inputs if it has adequate resources for the task at hand.

The type of data being processed, such as textual, audio, or visual data, can also influence which computing system is involved in the processing. Different systems can be optimized for different data types, allowing for more efficient data handling.

User identity can be another factor determining system participation. Certain computing systems might handle data related to specific users, especially in scenarios involving personalized data processing or enhanced privacy requirements.

The decision to engage a particular computing system in the processing sequence can be dynamic and based on real-time assessments of the factors mentioned. This flexibility allows the multi-furcated model to adapt to varying processing needs efficiently.

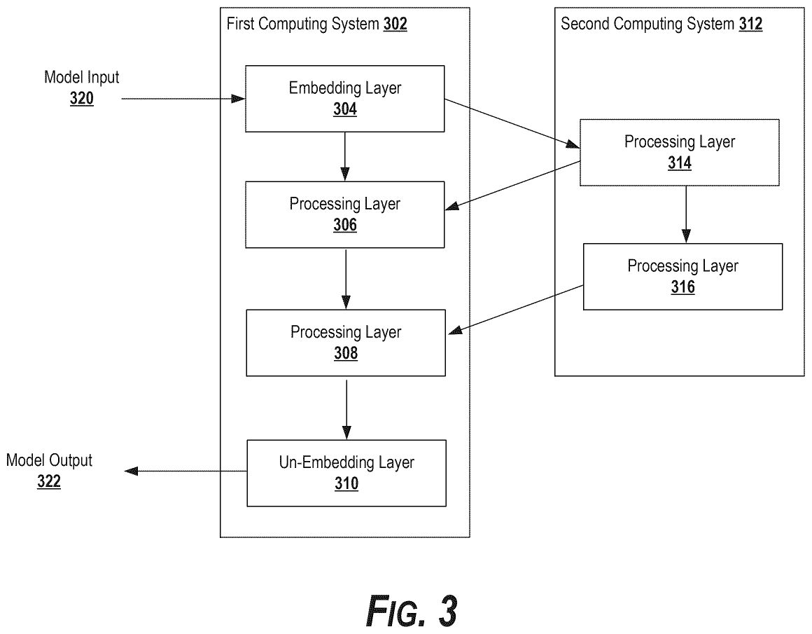

FIG. 3 illustrates a general architecture for a bi-furcated model. The model is implemented by two main components: a first computing system 302 and a second computing system 312.

The first computing system 302 can include several layers. An embedding layer 304 receives a model input 320 and converts it into a format suitable for further processing. This is followed by multiple processing layers, specifically processing layer 306 and processing layer 308, which perform intermediate computations on the data. An un-embedding layer 310 converts the processed data back into a human-readable format or a format suitable for further processing or output.

The second computing system 312 includes additional processing layers, specifically processing layer 314 and processing layer 316. These layers perform further computations on the data received (e.g., first intermediate representations) from the first computing system 302. The outputs of the layers 314 and 316 (e.g., which may be referred to as second intermediate representations) can be provided back to the first computing system 302.

The processed data is then output as a model output 322 from the first computing system 302, after passing through the un-embedding layer 310.

According to one example aspect, FIG. 3 displays a unidirectional data flow primarily from the second computing system 312 to the first computing system 302. In this arrangement, data processed by the processing layers 314 and 316 in the second computing system 312 flows towards the first computing system 302. This flow can enhance security by limiting the direction of data transmission, which may reduce the potential for unauthorized data interception.

Specifically, the diagram in FIG. 3 illustrates a communication protocol where the first computing system 302 makes only a single remote procedure call (RPC) to the second computing system 312 (e.g., the call from layer 304 to layer 314). This RPC can initiate the processing that involves both the first computing system 302 and the second computing system 312. By minimizing the number of RPCs to a single instance, this approach can reduce network latency and simplify the synchronization process between the two computing systems. Specifically, by having only a single RPC from the first computing system 302 to the second computing system 312, latency can be bottlenecked by the first computing system processing operations, not the second computing system processing operations.

Furthermore, as illustrated in FIG. 3, certain model portions in the first computing system 302, such as the processing layers 306 and 308, operate in parallel with the processing layers 314 and 316 in the second computing system 312. This parallel operation can optimize the use of computational resources by allowing simultaneous data processing across different layers and systems. This setup can expedite the overall data processing flow from the model input 320 to the model output 322.

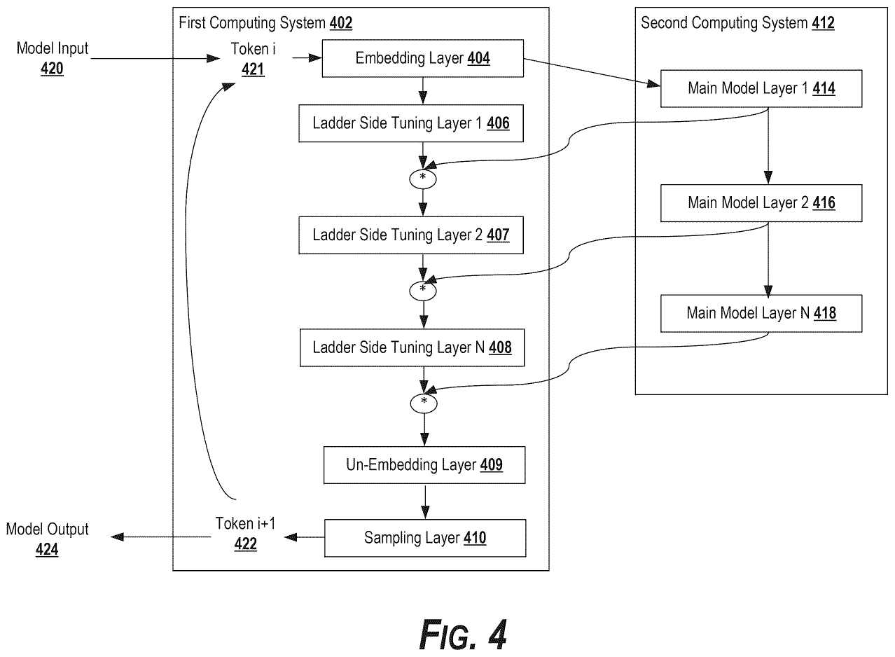

FIG. 4 illustrates a more detailed example architecture of a machine-learned model implemented by a first computing system 402 and a second computing system 412. Each system contains specific layers that process data sequentially.

The first computing system 402 can include an embedding layer 404, multiple ladder side tuning layers such as Ladder Side Tuning Layer 1 406, Ladder Side Tuning Layer 2 407, and Ladder Side Tuning Layer N 408, an un-embedding layer 409, and a sampling layer 410. These layers can process a model input 420, transforming it into intermediate tokens such as Token i 421 and Token i+1 422, and eventually leading to a model output 424.

The second computing system 412 can include main model layers such as Main Model Layer 1 414, Main Model Layer 2 416, and Main Model Layer N 418. These layers can process data received from the first computing system 402.

The model input 420 enters the first computing system 402 where it is processed through the embedding layer 404. The processed data is then sequentially modified by the ladder side tuning layers and the main model layers of the second computing system 412. The final processed data is converted back into an output format by the un-embedding layer 409 and sampled in the sampling layer 410 to produce the model output 424.

In the architecture depicted in FIG. 4, the use of Ladder Side-Tuning (LST) layers such as Ladder Side Tuning Layer 1 406, Ladder Side Tuning Layer 2 407, and Ladder Side Tuning Layer N 408 is a form of Parameter Efficient Inference (PEI) that focuses on fine-tuning models with a limited number of parameters while maintaining the main model layers, such as Main Model Layer 1 414, Main Model Layer 2 416, and Main Model Layer N 418, in a frozen state. This approach is designed to be memory and computation efficient compared to other PEI methods like LoRA.

In FIG. 4, alternatives to LST for parameter efficient adapter layers can include Low Rank Adaptation (LoRA) and other parameter-efficient adapter layers. These alternatives can be implemented in the first computing system 402 as part of the machine-learned model portions.

Thus, in some implementations, LoRA adapters can be used in place of LST layers such as Ladder Side Tuning Layer 1 406, Ladder Side Tuning Layer 2 407, and Ladder Side Tuning Layer N 408. LoRA involves modifying a small subset of the weights in a pre-trained model through low-rank matrix factorization. This method can be configured to update specific parameters that have a significant impact on the model's performance, while keeping the majority of the model parameters frozen.

However, the use of LoRA layers in the proposed distributed approach would require multiple bi-directinoal remote procedure calls (RPCs) which can significantly increase latency due to the need for frequent data exchanges between the first computing system 402 and the second computing system 412. Furthermore, the linear nature of LoRA transformations potentially allows the server to reconstruct the adapter weights, which is generally undesirable.

However, the LST approach in FIG. 4 addresses these issues effectively. The ladder side tuning layers operate with fewer RPCs, as all data transactions are primarily directed from the second computing system 412 to the first computing system 402, minimizing the two-way dependency and thus reducing the total inference latency. Additionally, since the data flow is predominantly one-way—from the server to the device—the risk of the server reconstructing the LST weights is reduced.

Thus, the illustrated architecture ensures that the parameter-efficient layers on the first computing system 402 handle initial processing tasks efficiently, while the more computationally intensive tasks are managed by the main model layers on the second computing system 412. This architecture not only optimizes the use of computational resources but also enhances the privacy and security of the data being processed.

In addition, in situations where the second computing system 412 is more powerful or otherwise has lower latency relative to the first computing system 402, it may be common that the computation of layers 414, 416, 418 finishes before the computation of layer 406 finishes. In such cases, the RPC calls from system 412 to system 402 can be batched. This enables some of all of the RPC calls from 412 to 402 to be accumulated into a single call, which further reduces overall network latency.

Furthermore, referring still to FIG. 4, training of the model (e.g., via backpropagation) can be controlled to occur only at the first computing system 402. This configuration allows for parameter updates and learning processes to occur without involving the second computing system 412, which contains the main model layers, thereby improving the privacy of the parameters of the layers contained at the first computing system 402.

In particular, during training or fine-tuning phases, when the model input 420 is processed through the embedding layer 404 and subsequently through the LST layers, gradients can be calculated using a loss function that measures the difference between the predicted output and the actual output at the sampling layer 410.

The backpropagation of errors starts from the sampling layer 410, moving backwards through the LST layers. At each of these layers, gradients are computed for the parameters that are specific to the LST layers. The gradients calculated during backpropagation are used to update the parameters of the LST layers within the first computing system 402.

Backpropagation does not need to proceed through the main model layers in the second computing system 412 because the first computing system 402 contains independent LST layers that allow for complete backward propagation and parameter updates within these layers, without requiring interaction with or dependency on the layers of the second system. This separation ensures that the data processing associated with backpropagation are confined to the first computing system 402.

By keeping backpropagation restricted to the first computing system 402, the system can quickly adapt to new data or changes in the input pattern without needing to communicate with or rely on the second computing system 412. This setup can be particularly beneficial for scenarios where rapid on-device learning is required, or where data privacy concerns restrict data sharing between devices.

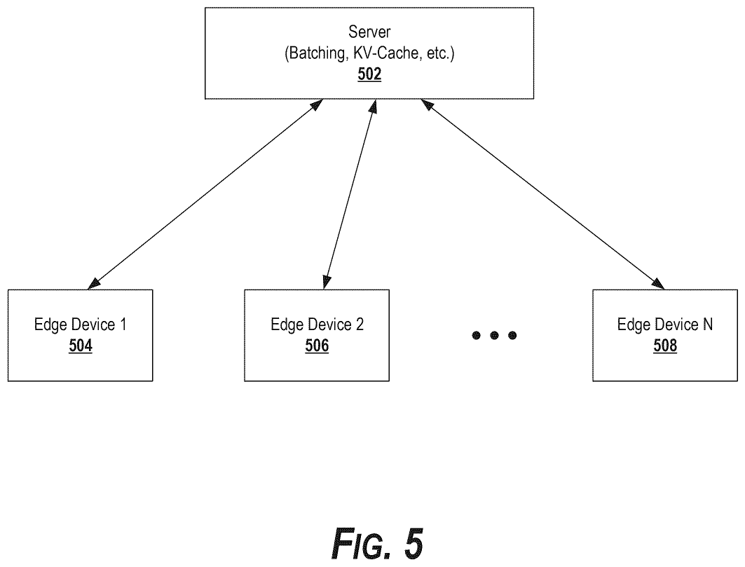

FIG. 5 illustrates an example network topology involving multiple edge devices and a central server.

Edge Device 1 504, Edge Device 2 506, and Edge Device N 508 represent a series of edge devices that can connect to the server 502. Each edge device can perform local computations and interact with the server 502 for more complex processing tasks. Each edge device can be an example of user devices or specialized hardware devices that perform initial data processing tasks locally. These devices can vary in computational power and functionality.

In turn, the server 502 can communicate with each edge device, including Edge Device 1 504, Edge Device 2 506, and Edge Device N 508. This communication can facilitate the distribution of tasks and data processing between the server 502 and the edge devices. As an example, the server 502 can be a server system equipped with computational resources to handle multiple simultaneous connections and tasks.

In some implementations, the server 502 can implement various server-side optimizations. These optimizations can include continuous batching, key-value caching, early exit strategies, and/or Virtual Large Language Model (VLLM) serving. These features can enhance the processing efficiency and performance of the server 502 as it interacts with multiple edge devices, such as Edge Device 1 504, Edge Device 2 506, and Edge Device N 508.

Continuous batching allows the server 502 to process multiple requests from the edge devices simultaneously, which can improve throughput. Early exit mechanisms enable the server 502 to terminate processing for simpler queries early, saving computational resources. VLLM can allow the server 502 to handle requests from multiple clients concurrently, optimizing server utilization and response times.

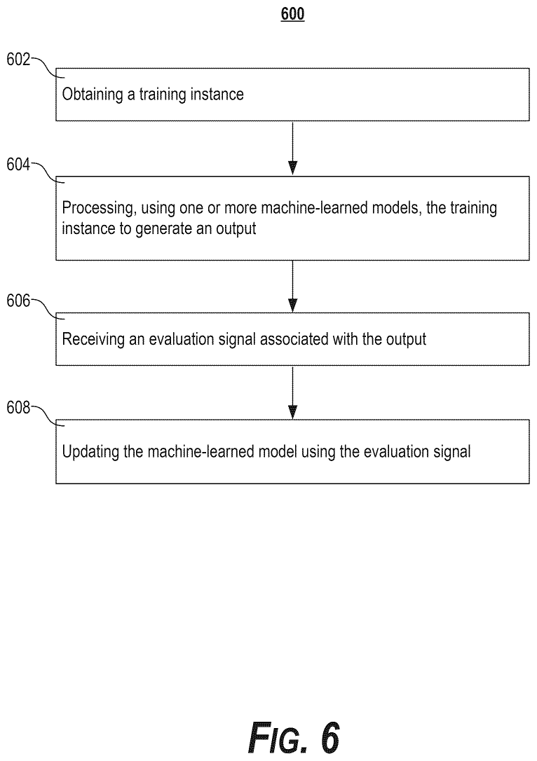

FIG. 6 depicts a flowchart of a method 600 for training one or more machine-learned models according to aspects of the present disclosure. For instance, an example machine-learned model can include a multi-furcated model.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types.

In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 600 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 600 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

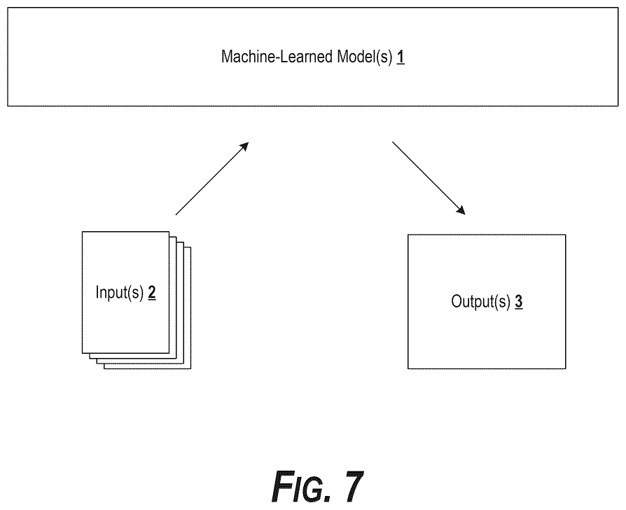

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of multi-furcated models, etc. Although various features, variations, and implementations described below are described with respect to machine-learned model(s) 1, it is to be understood that such features, variations, and implementations are to be understood as described with respect to each of the multi-furcated models described herein, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

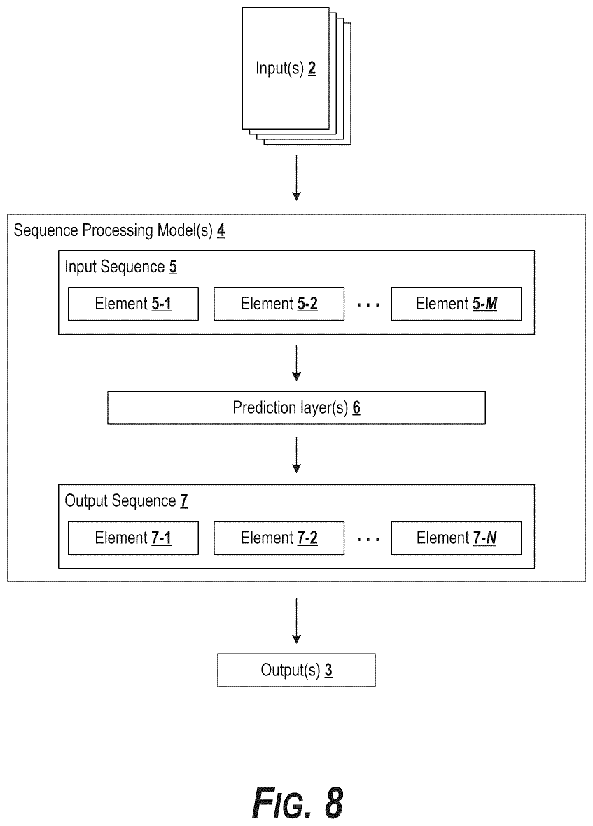

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

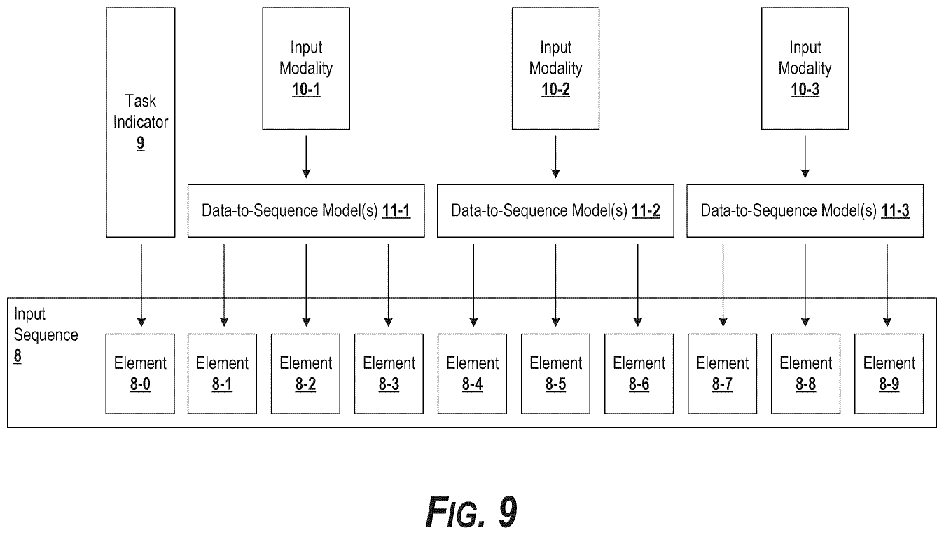

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

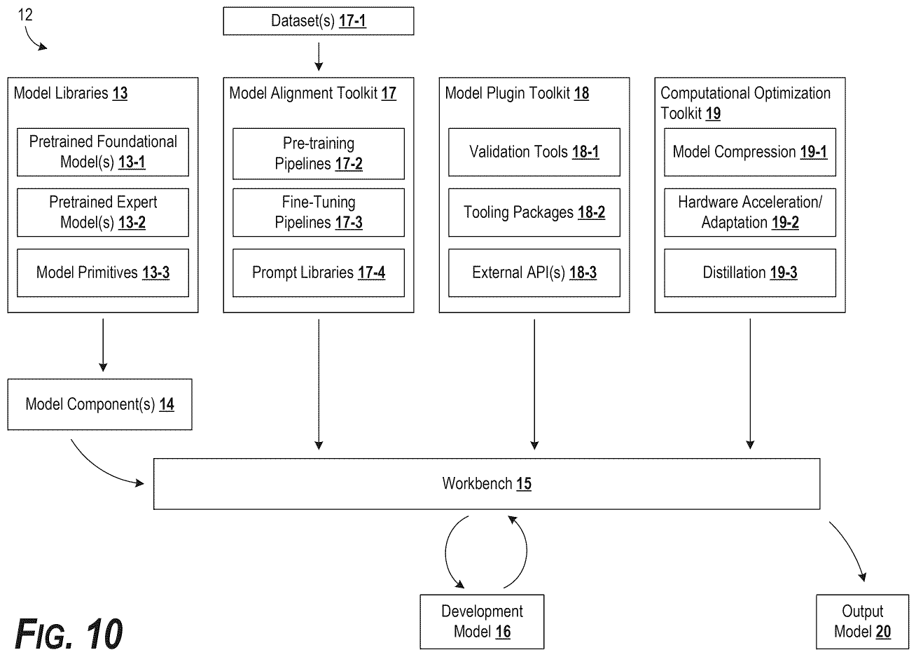

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

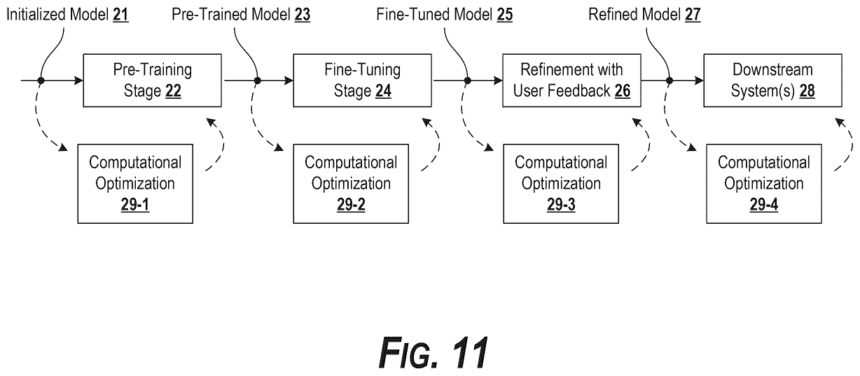

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1,. 29-4 can all be the same, all be different, or include at least some different optimization techniques.

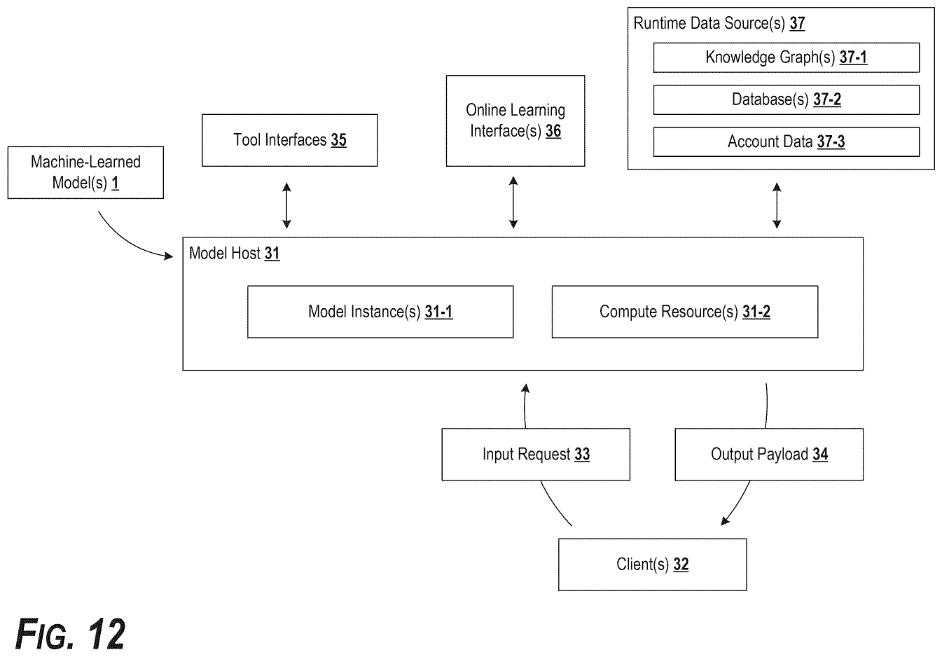

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

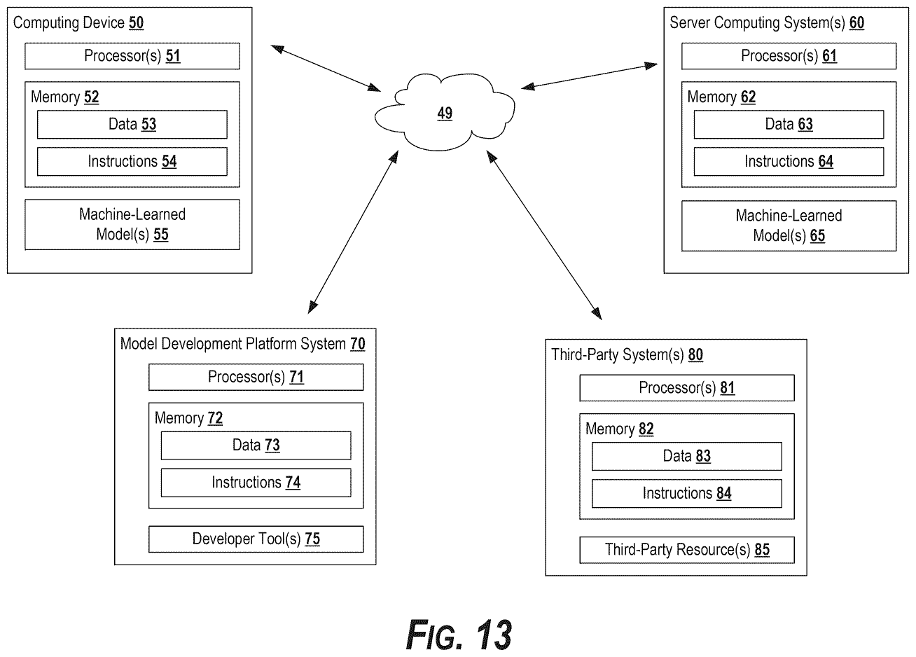

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

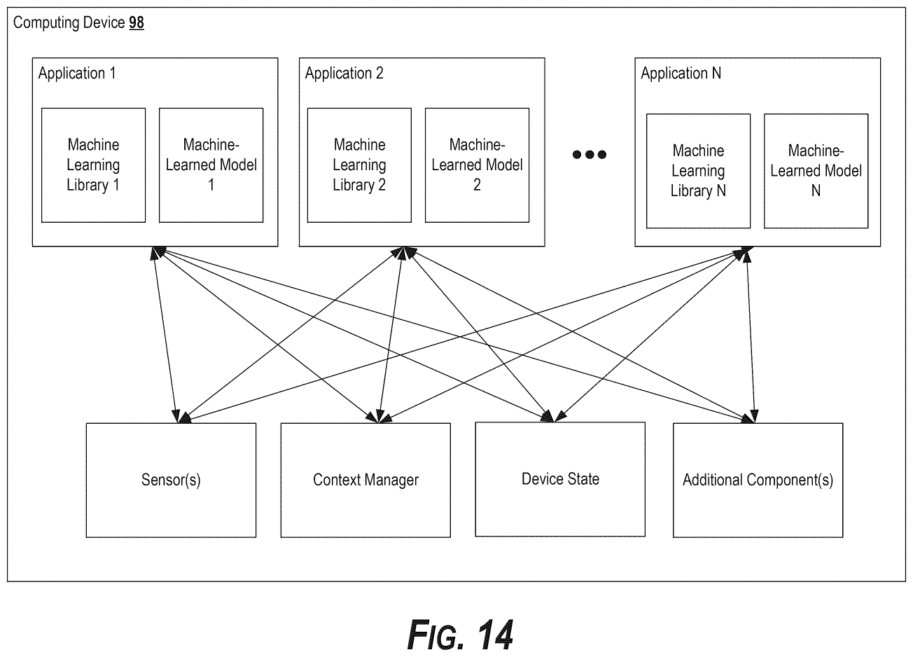

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

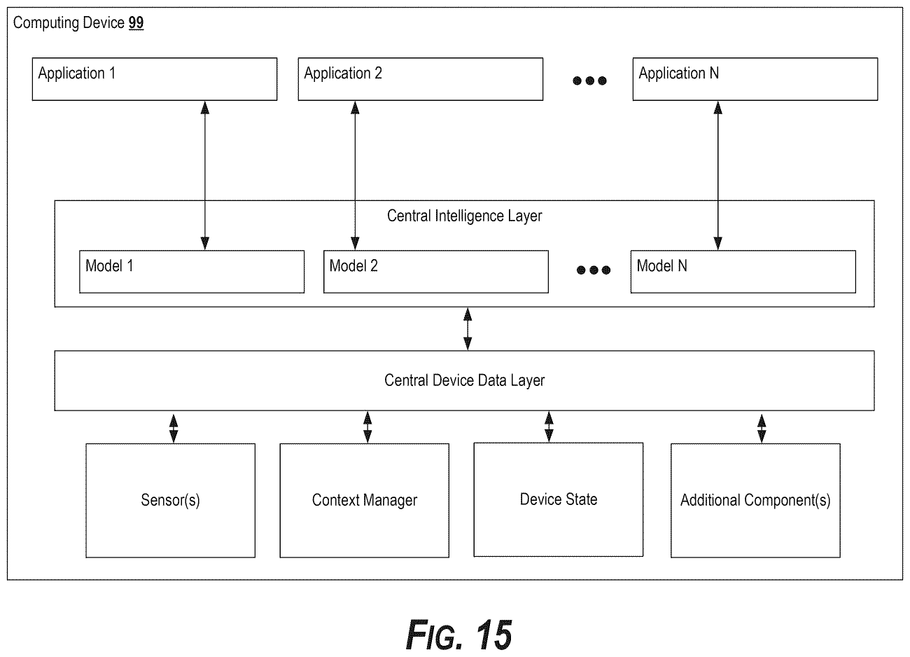

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A first computing system, comprising:
one or more processors; and
one or more non-transitory computer-readable media that collectively store:
one or more first machine-learned model portions comprising a first set of machine-learned model parameters,
wherein, to process a model input to generate a model output, the one or more first machine-learned model portions are configured to interoperate with one or more second, different machine-learned model portions comprising a second, different set of machine-learned model parameters,
wherein the one or more second, different machine-learned model portions are stored at a second, different computing system; and
instructions that, when executed by the one or more processors, cause the first computing system to perform operations, the operations comprising:
obtaining the model input;
processing the model input with at least some of the one or more first machine-learned model portions to generate a first intermediate representation;
transmitting the first intermediate representation to the second computing system;
receiving one or more second intermediate representations from the second computing system, the one or more second intermediate representations having been generated by the one or more second machine-learned model portions based at least in part on the first intermediate representation; and
generating the model output based at least in part one or more second intermediate representations.

2. The first computing system of claim 1, wherein generating the model output based at least in part one or more second intermediate representations comprises processing the one or more second intermediate representations with at least some of the one or more first machine-learned model portions to generate the model output.

3. The first computing system of claim 1, wherein, for each forward inference, and other than the transmission of the first intermediate representation from the first computing system to the second computing system, dataflow between the second machine-learned model portions and the first machine-learned model portions is unidirectional from the second machine-learned model portions to the first machine-learned model portions.

4. The first computing system of claim 1, wherein at least some of the one or more first machine-learned model portions comprise non-linear transformations.

5. The first computing system of claim 1, wherein at least some of the one or more first machine-learned model portions comprise ladder side tuning adapters.

6. The first computing system of claim 1, wherein the one or more second machine-learned model portions comprise a plurality of model layers, and wherein the one or more first machine-learned model portions comprise a plurality of ladder side tuning adapters respectively associated with the plurality of model layers, wherein each ladder side tuning adapter receives and processes one of the second intermediate representations output by one of the plurality of model layers to generate one of the first intermediate representations.

7. The first computing system of claim 1, wherein, in a forward inference dataflow, two or more of the first machine-learned model portions operate in parallel with two or more of the second machine-learned model portions.

8. The first computing system of claim 1, wherein at least some of the one or more first machine-learned model portions perform embedding of the model input and unembedding of the model output.

9. The first computing system of claim 1, wherein the first set of machine-learned model parameters were learned while holding the second set of machine-learned model parameters fixed.

10. The first computing system of claim 1, wherein a first number of parameters included in the first set of machine-learned model parameters is ten percent or less than a second number of parameters included in the second set of machine-learned model parameters.

11. The first computing system of claim 1, wherein, for each forward inference, the first computing system makes only a single remote procedure call to the second computing system.

12. The first computing system of claim 1, wherein the one or more second machine-learned model portions comprise one or more layers of an existing pre-trained model.

13. The first computing system of claim 1, wherein the first computing system consists of a user computing device.

14. The first computing system of claim 1, wherein the first computing system comprises a private computing system.

15. The first computing system of claim 1, wherein the second computing system has greater computational speed to the first computing system.

16. A second computing system configured to interoperate with a first, different computing system, the second computing system comprising:
one or more processors; and
one or more non-transitory computer-readable media that collectively store:
one or more second machine-learned model portions comprising a second set of machine-learned model parameters,
wherein, to facilitate processing of a model input to generate a model output, the one or more second machine-learned model portions are configured to interoperate with one or more first, different machine-learned model portions comprising a first, different set of machine-learned model parameters,
wherein the one or more first, different machine-learned model portions are stored at the first computing system; and
instructions that, when executed by the one or more processors, cause the second computing system to perform operations, the operations comprising:
receiving a first intermediate representation from the first computing system;
processing the first intermediate representation with the one or more second machine-learned model portions to generate one or more second intermediate representations; and
transmitting the one or more second intermediate representations to the first computing system.

17. The second computing system of claim 16, wherein neither the model input nor the model output are inferable from the first intermediate representation.

18. A distributed computing system comprising:
two or more different computing devices that respectively store two or more different subsets of a multi-furcated machine learning model configured to process a model input to generate a model output;
wherein a first computing device of the two or more different computing devices is configured to perform embedding operations to embed the model input and unembedding operations to generate the model output.

19. The distributed computing system of claim 18, wherein the two or more different computing devices that respectively store the two or more different subsets of the multi-furcated machine learning model comprise three or more different computing systems that respectively store three or more different subsets of the multi-furcated machine learning model.

20. The distributed computing system of claim 18, wherein the first computing device consists of a user computing device.
